(19) United States
(12) Patent Application Publication
(10) Pub. No.: US 2023/0064255 A1
(43) Pub. Date: Mar. 2, 2023

(54) NANOWIRE BUNDLE AND METHOD FOR MANUFACTURING SAME

(71) Applicant: SAMSUNG ELECTRO-MECHANICS CO., LTD., Suwon-si (KR)

(72) Inventors: Kyu Ho LEE, Suwon-si (KR); Woon Kyung LEE, Suwon-si (KR)

(73) Assignee: SAMSUNG ELECTRO-MECHANICS CO., LTD., Suwon-si (KR)

(21) Appl. No.: 17/702,236

(22) Filed: Mar. 23, 2022

(30) Foreign Application Priority Data
Sep. 1, 2021 (KR) 10-2021-0116439

(51) Int. Cl. H01B 7/00; H01B 1/02; H01B 3/08; H01B 13/00

(52) U.S. Cl. CPC H01B 7/0009; H01B 1/02; H01B 3/082; H01B 3/088; H01B 13/0036; B82Y 40/00

(57) ABSTRACT

The present disclosure provides a nanowire bundle including a plurality of cores including metal and arranged in a predetermined shape at regular intervals; a first glass portion including glass and covering the plurality of cores; and a second glass portion including glass and covering the first glass portion, and a method for manufacturing the nanowire bundle.

### CROSS-REFERENCE TO RELATED APPLICATION(S)

This application claims benefit of priority to Korean Patent Application No. 10-2021-0116439 filed on Sep. 1, 2021 in the Korean Intellectual Property Office, the disclosure of which is incorporated herein by reference in its entirety.

### TECHNICAL FIELD

The present disclosure relates to a nanowire bundle and a method for manufacturing the same.

### BACKGROUND

A nanowire has a nano-size diameter, and may include a core formed of metal, and a cover including glass, formed to surround the core.

Disclosed is a technology capable of separating a unit for melting the core material and a unit for melting the cover material, and using a component having a higher melting point as the core material, compared to a component of the cover material.

Using this technology, it is possible to manufacture a nanowire having a metal material such as nickel (Ni) as a core surrounded by a glass material as a cover. Through this, the nanowire may be produced continuously and rapidly as long as raw materials for the metal core and the glass cover are continuously supplied.

In addition, nanowire manufactured in this manner may be combined as a plurality of nanowires to manufacture a nanowire bundle used for manufacturing an electronic component such as a secondary battery, a capacitor, or the like.

Conventionally, several single nanowires may be collected and then combined into a nanowire bundle by heat treatment, and the nanowire bundle may be cut and manufactured as a wafer used as a material for an electronic component.

However, when heat treatment is performed after simply combining a plurality of nanowires, a temperature of nanowires located in a peripheral region and a temperature of nanowires located in a central region may be changed, depending on a heat transfer rate.

As a physical size of a nanowire bundle produced increases, deviation in thickness of individual nanowires and deviation in gap between nanowires may occur. Accordingly, since a fine imbalance overall may be generated when the nanowire bundle is viewed as a 3D (three-dimensional) structure, quality of a wafer may be deteriorated when the nanowire bundle is cut and manufactured into the wafer.

### SUMMARY

An aspect of the present disclosure is to provide a nanowire bundle capable of having a uniform overall shape in terms of a three-dimensional structure, and a method for manufacturing the same.

According to an aspect of the present disclosure, a nanowire bundle includes a plurality of cores including metal and arranged in a predetermined shape at regular intervals; a first glass portion including glass and formed to cover the plurality of cores; and a second glass portion including glass and formed to cover the first glass portion.

According to an aspect of the present disclosure, the plurality of cores may include at least one of nickel (Ni), copper (Cu), or palladium (Pd).

According to an aspect of the present disclosure, the plurality of cores may be formed to have a circular columnar shape, and the second glass portion may be formed to have a circular columnar shape.

According to an aspect of the present disclosure, the plurality of cores may be formed to have a polygonal columnar shape, and the second glass portion may be formed to have a polygonal columnar shape.

According to an aspect of the present disclosure, a portion of the plurality of cores may include metal, different from metal of other cores.

According to an aspect of the present disclosure, a plurality of zones may be arranged radially in the second glass portion, wherein cores disposed in the plurality of zones may include different metals each other.

According to an aspect of the present disclosure, among the plurality of cores, a portion thereof may have a diameter, different from a diameter of other respective cores.

According to an aspect of the present disclosure, a plurality of zones may be arranged radially in the second glass portion, wherein average diameters of cores disposed in the plurality of zones may be different each other.

According to another aspect of the present disclosure, a method for manufacturing a nanowire bundle, includes coating glass on metal by a spinning process to prepare a nanowire including a core and a cover, performing the spinning process as a plurality of spinning processes in parallel to produce the nanowire as a plurality of nanowires, and accommodating the plurality of nanowires in a mold, coating the plurality of nanowires accommodated in the mold with a second glass, and heating and compressing the resultant coatings, and integrating a plurality of covers materials to prepare a first glass portion covering the plurality of cores, and using the second glass to prepare a second glass portion covering the first glass portion.

According to an aspect of the present disclosure, the plurality of nanowires may be formed using a metal, different from a metal of other cores, in a portion of the plurality of cores.

According to an aspect of the present disclosure, a plurality of zones may be arranged radially in the second glass portion, wherein cores disposed in the plurality of zones may include different metals each other.

According to an aspect of the present disclosure, the plurality of nanowires may be formed such that a portion of the plurality of cores may have a diameter, different from a diameter of other respective cores.

According to an aspect of the present disclosure, a plurality of zones may be arranged radially in the second glass portion, wherein each of the plurality of nanowires may be manufactured such that average diameters of cores disposed in the plurality of zones are different each other.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a view schematically illustrating a method for manufacturing a nanowire bundle according to an embodiment of the present disclosure.

FIG. 2 is a cross-sectional view illustrating a state before coating a plurality of nanowires with a second glass and heating the coating.

FIG. 3 is a cross-sectional view illustrating a state after coating a plurality of nanowires with a second glass and heating the coating.

FIG. 4 is a perspective view of a nanowire bundle manufactured using the method of FIG. 1.

FIG. 5 is a perspective view illustrating a portion A of FIG. 4.

FIG. 6 is a cross-sectional view illustrating a state after coating a plurality of nanowires with a second glass before heating the coating, according to another embodiment of the present disclosure.

FIG. 7 is a cross-sectional view illustrating a state after coating a plurality of nanowires with a second glass and heating the coating, in FIG. 6.

FIG. 8 is a cross-sectional view illustrating a state after coating a plurality of nanowires with a second glass before heating the coating, according to another embodiment of the present disclosure.

FIG. 9 is a cross-sectional view illustrating a state after coating a plurality of nanowires with a second glass and heating the coating, in FIG. 8.

FIG. 10 is a cross-sectional view illustrating a state after coating a plurality of nanowires with a second glass before heating the coating, according to another embodiment of the present disclosure.

FIG. 11 is a cross-sectional view illustrating a state after coating a plurality of nanowires with a second glass and heating the coating, in FIG. 10.

### DETAILED DESCRIPTION

Hereinafter, preferred embodiments of the present disclosure will be described with reference to the accompanying drawings.

However, embodiments of the present disclosure may be modified in various other forms, and the scope of the present disclosure is not limited to the embodiments described below.

In addition, embodiments of the present disclosure may be provided to more completely describe the present disclosure to those having average knowledge in the art.

Therefore, the shapes and sizes of elements in the drawings may be exaggerated for clarity, and elements indicated by the same reference numerals in the drawings may be the same elements.

In addition, the same reference numerals may be used throughout the drawings for portions having similar functions and functions.

In addition, “including” or “comprising” a certain component throughout the specification refers that other components may be further included rather than excluding other components unless specifically stated to the contrary.

A nanowire bundle of the present disclosure may be manufactured by the following manufacturing process.

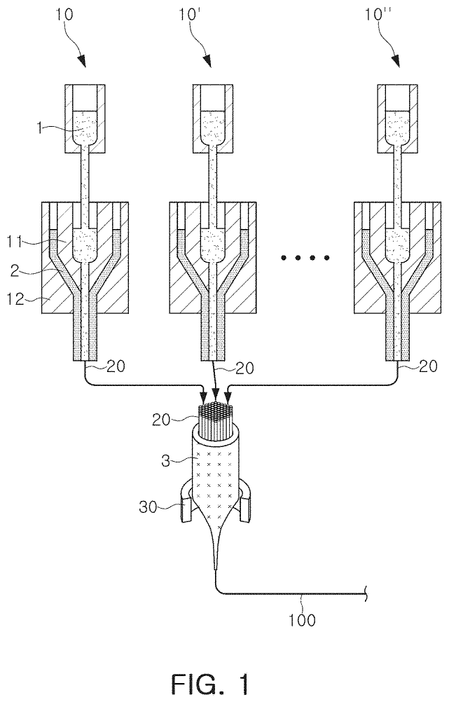

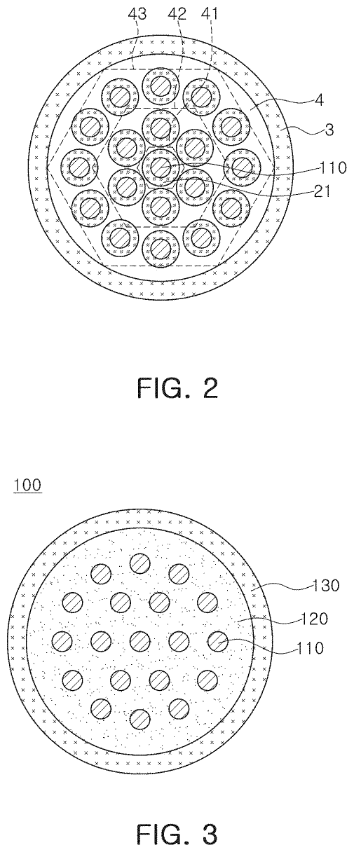

FIG. 1 is a view schematically illustrating a method for manufacturing a nanowire bundle according to an embodiment of the present disclosure, FIG. 2 is a cross-sectional view illustrating a state before coating a plurality of nanowires with a second glass and heating the coating, and FIG. 3 is a cross-sectional view illustrating a state after coating a plurality of nanowires with a second glass and heating the coating.

Referring to FIGS. 1 to 3, first, first glass 2 may be coated around metal 1 in a spinning process using a spinning device (e.g., 10, 10′, and 10″), to prepare a nanowire 20 including a core 110 and a cover 21 and having a long linear shape. In this embodiment, the metal 1 may be nickel (Ni), which may frequently be used as a material for an internal electrode, but the present disclosure is not limited thereto.

For example, as the metal 1, various metal materials such as copper (Cu) having superior electrical conductivity, compared to nickel, palladium (Pd) having a higher melting point and excellent electrode connectivity, as compared to nickel, or the like, may be used.

In this case, a plurality of spinning devices 10, 10′, and 10″ may be applied in parallel, and a plurality of spinning processes may be performed in parallel, to manufacture a plurality of nanowires 20, respectively. In this case, reference numeral 11 denotes a metal lead-out portion, and reference numeral 12 denotes a glass lead-out portion.

Next, the plurality of nanowires 20 manufactured by the spinning devices 10, 10′, and 10″ may be coated with second glass 3 accommodated in a mold in a state in which a single bundle shape is maintained, and may be heated by a heater 30 and compressed, to prepare a nanowire bundle 100 in which the plurality of nanowires 20 are covered with the second glass 3.

In this case, a plurality of covers 21 arranged adjacent to each other in an internal region 4 of the second glass 3 may be integrated to form a first glass portion 120, as a single body, covering a plurality of cores 110, and the second glass 3 may be cured to prepare a second glass portion 130 covering the first glass portion 120.

In addition, the second glass portion 130 may serve as a binder that may be removed by an FAB process when an electronic component is manufactured using the nanowire bundle 100 later.

The internal region 4 of the nanowire bundle 100 may be divided into several regions, for example, a first region 41, which is an inside region, a second region 42, which is an intermediate region, and a third region 43, which is a peripheral region.

In this embodiment, these regions may have structures in which a plurality of concentric circles having different diameters are radially arranged, and the first region 41 may have one (1) nanowire, the second region 42 may have a total of six (6) nanowires, and the third region 43 may have a total of twelve (12) nanowires.

When individual nanowires are conventionally collected to form a bundle, an amount of heat transferred to the nanowires 20 for each of the regions may be changed, due to interference between nanowires 20 adjacent to each other and a distance between the bundle and the heater 30, which may be a heat source, during heating.

In this embodiment, spinning temperatures of the first to third regions 41, 42, and 43 may be controlled differently by changing presence or absence of the heater 30 or a heating intensity during spinning.

In this case, the heat treatment may be performed in a continuous process before residual heat disappears, to reduce a difference in amount of heat transfer generated due to a distance between a bundle and the heater 30 and interference between nanowires 20 adjacent to each other during conventional heat treatment.

When the spinning temperatures of the first to third regions 41, 42, and 43 are different as described above, it is possible to control dispersion of bonding strength or the like when the plurality of nanowires 20 are bonded. Through this, in the internal region 4 of the second glass portion 130, it is possible to manufacture a nanowire bundle 100 in which a thickness of and a gap between the plurality of nanowires 20 are substantially uniformly repeated.

Therefore, in the nanowire bundle 100 manufactured according to an embodiment of the present disclosure, each of the nanowires may be produced under different conditions as needed, and then one nanowire bundle may be manufactured by combining the produced nanowires. By doing so, the manufactured nanowire bundle may have a uniform shape when viewed as a whole three-dimensional structure.

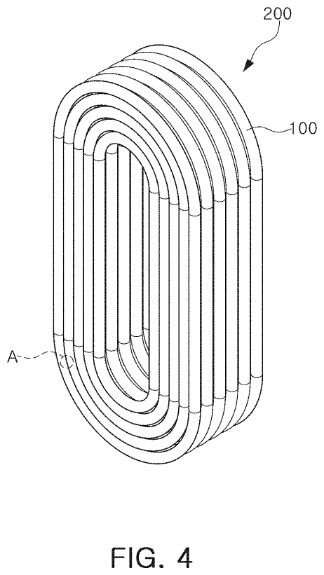

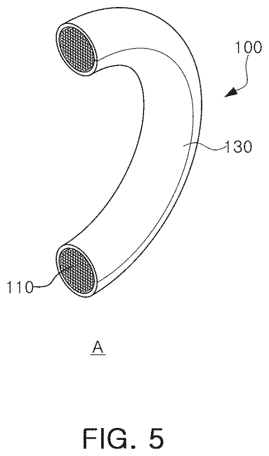

The nanowire bundle 100 manufactured in this manner may be made to form a structure 200 as in FIGS. 4 and 5 by a further winding process and the like.

The structure 200 may be cut to have required straight sections in a predetermined thickness by wire sawing or the like, to be processed to form a wafer, and the wafer may be used for manufacturing electronic components.

To improve quality of the nanowire bundle, when the nanowire bundle is processed to form a wafer, the nanowires should be configured to have respectively a uniform thickness and to have a uniform gap therebetween.

As a conventional method, when separately manufactured individual nanowires are combined and then formed into a bundle by heat treatment, a temperature of nanowires located in a peripheral region and a temperature of nanowires located in a central region may be changed by a heat transfer rate.

In this case, as a physical size of a nanowire bundle produced increases, deviation in thickness and deviation in gap in a radial direction of the nanowire bundle may increase due to a temperature difference between nanowires. This may cause a microscopic imbalance in the nanowire bundle when viewed as a whole.

As in this embodiment, when a nanowire bundle including a plurality of nanowires is manufactured using a parallel spinning process, production conditions (e.g., a temperature or the like) of the plurality of nanowires constituting interior and exterior regions of the nanowire bundle may be efficiently controlled for each position.

Therefore, it is possible to reduce deviation in thickness of each of and deviation in gap between the plurality of nanowires, to manufacture a nanowire bundle having an overall uniform shape in terms of a three-dimensional structure.

Therefore, the nanowire bundle configured as described above may be used to manufacture a wafer having a substantially uniform structure, and such a wafer may be made into electronic components such as a capacitor having excellent quality by an FAB process.

In this embodiment, as the second glass 3 is compressed by heat treatment, the plurality of shell materials 21 arranged adjacent to each other in the plurality of nanowires come into contact with each other to form the first glass portion 120, which is unitary.

In this case, a shape of the second glass portion 130 that determines a shape of the nanowire bundle 100 to be completed, and a shape of the core 110 arranged in the internal region 4 of the second glass portion 130, may be determined, according to an arrangement of the plurality of nanowires.

As in FIG. 3, in an embodiment of the present disclosure, the core 110 of each of the nanowires may be formed to have a circular columnar shape, and the second glass portion 130 may be formed to have a circular columnar shape corresponding to the shape of the core 110.

In the present disclosure, the shape of the second glass portion 130 and the shape of the core 110 are not limited to these shapes, and when the arrangement of the nanowires disposed in the internal region 4 of the second glass 3 is changed, the shape of the second glass portion 130 and the shape of the core 110 may be variously changed.

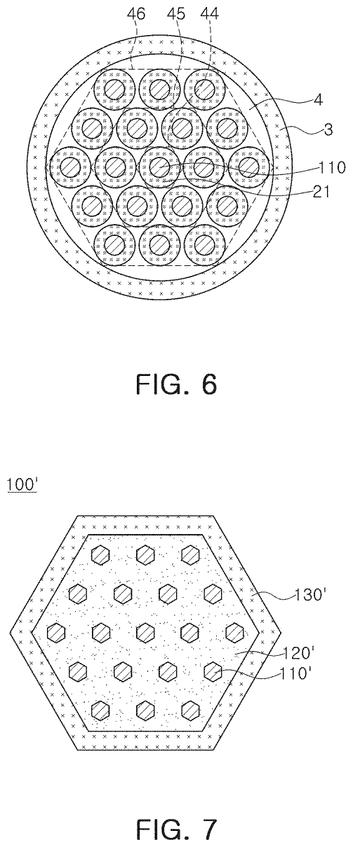

For example, as illustrated in FIG. 6, six (6) nanowires located in a second region 45 may be arranged to exhibit a hexagonal band shape, and twelve (12) nanowires located in a third region 46 may be arranged to exhibit a hexagonal band shape.

Thereafter, when heat treatment is performed as illustrated in FIG. 7, a core 110′ of a nanowire may be formed to have a hexagonal columnar shape, and a second glass portion 130′ may be formed to have a hexagonal columnar shape corresponding to the shape of the core 110′.

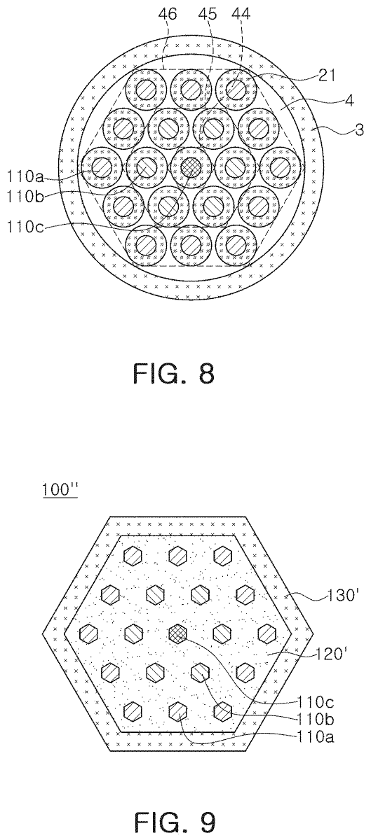

In addition, as illustrated in FIG. 8, according to another embodiment of the present disclosure, a plurality of nanowires respectively having a plurality of cores 110a, 110b, and 110c having different electrical properties or material properties may be combined to manufacture a nanowire bundle 100″ including the various types of cores 110a, 110b, and 110c.

For example, the nanowire bundle 100″ of this embodiment may be formed to include metal, different from metal of other cores in some of the plurality of cores.

Since nanowires have different properties such as melting point, viscosity, or the like when characteristics or components of core materials are different, in order to have uniform thicknesses of and uniform gaps between the nanowires, it may be necessary to change injection conditions for injectors.

In this embodiment, temperatures or the like of the injectors, which inject the nanowires, may be individually controlled under conditions suitable to electric properties, material properties, or the like of each of the cores 110a, 110b and 110c, to easily manufacture the nanowire bundle 100″ formed of a combination of a plurality of nanowires including the various types of core 110a, 110b and 110c and having a uniform internal structure when viewed from a three-dimensional structure.

Therefore, as illustrated in FIG. 9, in the nanowire bundle 100″, a core in a portion of the plurality of nanowires may be formed of metal, different from metal of other cores.

In this case, the components of the core materials may be different from each other by changing types of materials of metal input to the plurality of spinning devices 10, 10′, and 10″ of FIG. 1 to be different from each other.

For example, a core 110c of the nanowire in a region 44, which is am inside region, may be formed of palladium (Pd), a core 110b of the nanowire in a region 45, which is an intermediate region, may be formed of nickel (Ni), and a core 110c of the nanowire in a region 46, which is a peripheral region, may be formed of copper (Cu).

This is illustrative that may be configured to combine several types of conductive materials having different melting points, but materials of cores in the present disclosure are not limited thereto.

According to this structure, a geometric shape of the nanowire bundle 100″ may be repeated in the same manner as in the previous embodiments, but a core therein may have a structure, different from structures of the nanowire bundles of the previous embodiments.

Since a wafer using the nanowire bundle manufactured in this manner may be used to manufacture a capacitor, a substrate, or the like, and a type and arrangement of the core may be freely set according to use and characteristics of other manufactured products, a degree of freedom in design may greatly increase.

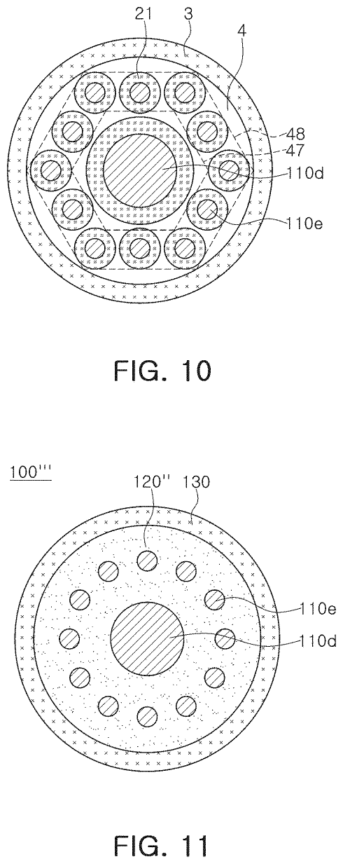

In addition, as illustrated in FIG. 10, according to another embodiment of the present disclosure, a plurality of nanowires respectively having different shapes or different sizes of cores 110d and 110e may be combined to manufacture a nanowire bundle 100″ ‘ including the various types of cores 110d and 110e.

For example, the nanowire bundle 100″ ’ of this embodiment may be formed to have a diameter of a portion of a plurality of cores, different from a diameter of other cores.

In this case, in the plurality of spinning apparatuses 10, 10′, and 10″ of FIG. 1, a size of an outlet of the metal lead-out portion 11 may be different from a size of an outlet of the glass lead-out portion 12, to have different diameters of cores therefrom.

When cores of nanowires are formed of the same material, an injection area when injected from an injector may be inversely proportional to an injection speed, and may be proportional to an input amount of a material.

Therefore, input amounts of materials by injectors injecting each nanowires, injection speeds of the injectors, and the like may be individually controlled to change diameters of cores of the nanowires to be injected.

The plurality of nanowires manufactured to have core materials of different shapes or different sizes in this manner may be combined to easily manufacture the nanowire bundle 100″ ′ formed of a combination of a plurality of nanowires having different shapes or different sizes and having a uniform internal structure when viewed from a three-dimensional structure.

Therefore, as illustrated in FIG. 11, in the nanowire bundle 100′″ a core material in a portion of the plurality of nanowires may be formed to have a size, different from a size of other cores.

For example, when an internal region of the nanowire bundle 100′″ is divided into a region 47, which is an inside region, and a region 48, which is a peripheral region, located around the region 47, and, to individually form cores of nanowires, an injection amount of metal injected into the region 47 is controlled to be different from an injection amount of metal injected into the region 48, and an injection speed of metal injected into the region 47 is controlled to be identical to an injection speed of metal injected into the region 48, a diameter of a core 110d of nanowires in the region 47 may be formed to be different from a diameter of a core 110e of the nanowire in the region 48.

In this embodiment, the diameter of the core 110d of the region 47 may be formed to be larger than the diameter of the core 110e of the region 48, but the present disclosure is not limited thereto.

Therefore, sizes of the nanowires in the nanowire bundle may be easily changed for each position to flexibly design a structure of a wafer, as needed.

According to an embodiment of the present disclosure, a nanowire bundle having an overall uniform shape in terms of a three-dimensional structure may be provided.

While example embodiments have been illustrated and described above, it will be apparent to those skilled in the art that modifications and variations could be made without departing from the scope of the present disclosure as defined by the appended claims.

What is claimed is:

1. A nanowire bundle comprising:
a plurality of cores including metal and arranged in a predetermined shape at intervals;
a first glass portion including glass and covering the plurality of cores; and
a second glass portion including glass and covering the first glass portion.

2. The nanowire bundle of claim 1, wherein the plurality of cores comprise at least one of nickel (Ni), copper (Cu), or palladium (Pd).

3. The nanowire bundle of claim 1, wherein the plurality of cores have a circular columnar shape, and the second glass portion has a circular columnar shape.

4. The nanowire bundle of claim 1, wherein the plurality of cores have a polygonal columnar shape, and the second glass portion has a polygonal columnar shape.

5. The nanowire bundle of claim 1, wherein one of the plurality of cores comprises metal, different from metal of other cores.

6. The nanowire bundle of claim 5, wherein, among the plurality of cores, a first core includes nickel (Ni), a second core includes copper (Cu), and a third core includes palladium (Pd).

7. The nanowire bundle of claim 5, wherein a plurality of zones are arranged radially in the second glass portion,
wherein cores disposed in the plurality of zones comprise metals different from each other.

8. The nanowire bundle of claim 7, wherein the plurality of cores comprise one of nickel (Ni), copper (Cu), or palladium (Pd).

9. The nanowire bundle of claim 1, wherein, among the plurality of cores, one core has a diameter, different from a diameter of other respective cores.

10. The nanowire bundle of claim 9, wherein a plurality of zones are arranged radially in the second glass portion,
wherein average diameters of cores disposed in the plurality of zones are different from each other.

11. A method for manufacturing a nanowire bundle, comprising:
parallelly coating glass on metal by parallel spinning processes to respectively form a plurality of nanowires each comprising a core and a cover;
accommodating the plurality of nanowires in a mold;
coating the plurality of nanowires accommodated in the mold with a second glass, and heating and compressing the resultant coatings; and
integrating a plurality of covers to prepare a first glass portion covering the plurality of cores, and using the second glass to prepare a second glass portion covering the first glass portion.

12. The method of claim 11, wherein a core of one of the plurality of nanowires is formed using a metal, different from a metal used to form other cores.

13. The method of claim 12, wherein, among the plurality of nanowires, a core of a first nanowire is formed by nickel (Ni), a core of a second nanowire is formed by copper (Cu), and a core of a third nanowire is formed by palladium (Pd).

14. The method of claim 11, wherein a plurality of zones are arranged radially in the second glass portion,
wherein cores disposed in the plurality of zones comprise metals different from each other.

15. The method of claim 14, wherein the plurality of cores comprise one of nickel (Ni), copper (Cu), or palladium (Pd).

16. The method of claim 11, wherein one of the plurality of cores has a diameter, different from a diameter of other cores.

17. The method of claim 16, wherein a plurality of zones are arranged radially in the second glass portion,
wherein average diameters of cores disposed in the plurality of zones are different from each other.

18. The method of claim 11, wherein the spinning processes are independently controlled when forming respective ones of the plurality of nanowires, based on relative diameters of the plurality of nanowires, relative positions of the plurality of nanowires in the nanowire bundle, and/or metal respectively used to form the plurality of nanowires.

19. The method of claim 11, wherein injectors to form respective ones of the plurality of nanowires are independently controlled so that temperatures and injection speeds of the injectors are controlled based on relative diameters of the plurality of nanowires, relative positions of the plurality of nanowires in the nanowire bundle, and/or metal respectively used to form the plurality of nanowires.
